(19) United States
(12) Patent Application Publication
(10) Pub. No.: US 2003/0146008 A1
(43) Pub. Date: Aug. 7, 2003

(54) Hand held power tool with an improved functionality

(76) Inventor: Paolo Andriolo, Vicenza (IT)

Correspondence Address: James V. Costigan, Esq., Hedman & Costigan, P.C., Suite 2003, 1185 Avenue of the Americas, New York, NY, 10036-2646, US

(21) Appl. No.: 10/326,902

(22) Filed: Dec. 20, 2002

(30) Foreign Application Priority Data
Dec. 21, 2001 (IT) VI2001A000264

(51) Int. Cl. B27C 3/08

(52) U.S. Cl. 173/217; 173/170

(57) ABSTRACT

A hand held power tool with an improved functionality, comprising a grip (16) with a configuration which allows a much more comfortable and efficient use of the machine, especially in the case of prolonged and/or professional use; advantage of use is obtained without jeopardizing the encumbrance, which remains equivalent to that of traditional machines.

The present invention relates to a hand held power tool with an improved functionality.

More specifically, the invention relates to an electrically driven power tool, such as an electric drill, screwdriver or a circular saw.

At present, these machines generally comprise a main body, inside which there is an electric motor which drives the rotation of a chuck, on which a specific work tool is assembled.

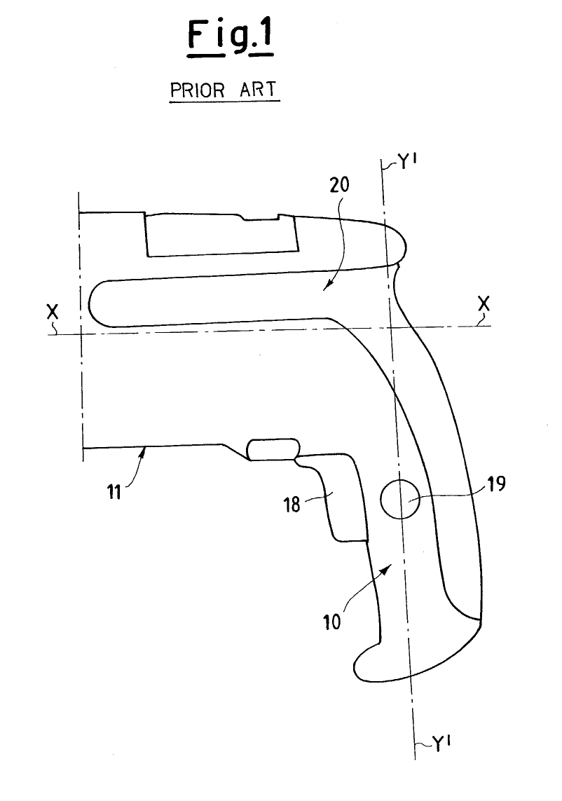

With specific reference to FIG. 1, which represents a partial side view of an electric drill of the traditional type, it can be clearly seen that the hand held power tool comprises, in particular, a grip 10, arranged in a substantially perpendicular direction to the longitudinal axis X of the main body 11 of the machine (which in the specific case illustrated in FIG. 1, coincides with the rotation axis of the tool-holder chuck).

Furthermore, inside the grip 10 there is a start and drive switch which is activated by means of a push-button 18 protruding from the external profile of the grip, which can move in a substantially perpendicular direction to the axis Y′ of FIG. 1.

Although this traditional machine-tool configuration is generalized, it does not correspond, however, to the optimum requisites for comfort required for a correct ergonomic design.

The intensive use, for example in professional environments, of power tools characterized by an incorrect or non-optimum ergonomic design can cause a series of negative consequences which make the use of the equipment laborious and uncomfortable.

In particular, the accumulation of biomechanical stress can take place on the hand and arm, with a consequent increase in the risk of the onset of muscular-skeletal traumas, such as tendinitis, carpal tunnel syndrome, Raynaud syndrome, muscular pain, tenosynivitis or epicondylitis.

The prolonged use of a similar hand held power tool subsequently causes fatigue in the tendons and muscles, reduces hand functionality and control capacity and consequently the capacity of effecting precision work for a long period.

All of this results in a decrease in work efficiency and productivity, due to the greater request for human strength to be applied to the power tool, prolonged learning times for new operations and lower work quality, together with an increase in error incidence and higher consumption or waste of material.

Finally, there is also the possibility of an increase in the risk of industrial accidents, as a consequence of the reduced capacity to react in emergency situations.

An objective of the present invention is therefore to eliminate the technical drawbacks reported and, in particular, to produce a hand held power tool with an improved functionality, which allows the user to apply human strength more efficiently, whatever type of grip is adopted.

Another objective of the present invention is to indicate a hand held power tool with an improved functionality, which allows the user to maintain, during use, a so-called “neutral posture” of the hand and forearm, known to ergonomists as being the most advantageous in terms of comfort and prevention of a series of pathologies connected with the use of power tools.

An additional objective of the invention is to produce a hand held power tool with an improved functionality, which maintains safety and reliability characteristics, with respect to hand held power tools of the traditional type, without jeopardizing encumbrance, which remains equivalent to that of traditional machines.

These and other objectives, according to the present invention, are achieved by the production of a hand held power tool with an improved functionality, according to claim 1, to which reference should be made for the sake of brevity.

Further technical characteristics of the invention are defined in the subsequent claims.

The hand held power tool according to the invention can be advantageously distinguished by the particular configuration of the grip and accessories relating thereto, so as to allow much a more comfortable and less tiring use, with a consequent increase in work productivity and efficiency, with a drastic reduction in fatigue on the part of the user.

Detailed studies in the field have, in fact, verified that a lesser degree of stress in the holding and control of a tool, in particular a power tool, is obtained when the forearm and hand are working in a so-called “neutral posture”, whereby the limb is in a state of perfect muscular and articular equilibrium.

The “neutral posture” of the hand and forearm is obtained, in particular, when the fingers are slightly bent on the three articulations (with a bending degree which gradually increases from the index finger to the little finger), the thumb is in semi-opposition with respect to the other fingers and the wrist of the forearm is slightly stretched with a mild inclination of the ulna.

In addition to advantages relating to the muscular-skeletal condition, further studies have demonstrated that a correct working position of the hand and forearm (suitable for obtaining the so-called “neutral posture”) considerably reduces the extent of vibrations from the hand-grip interface to the user's wrist, thus significantly reducing excessive muscular stress and bone-articular ailments.

Further characteristics and advantages of a hand held power tool with an improved functionality, according to the present invention, will appear more evident from the following illustrative but non-limiting description, referring to the enclosed schematic drawings, wherein:

FIG. 1 is a partial side view of a hand held power tool, in particular a power tool, of the traditional type;

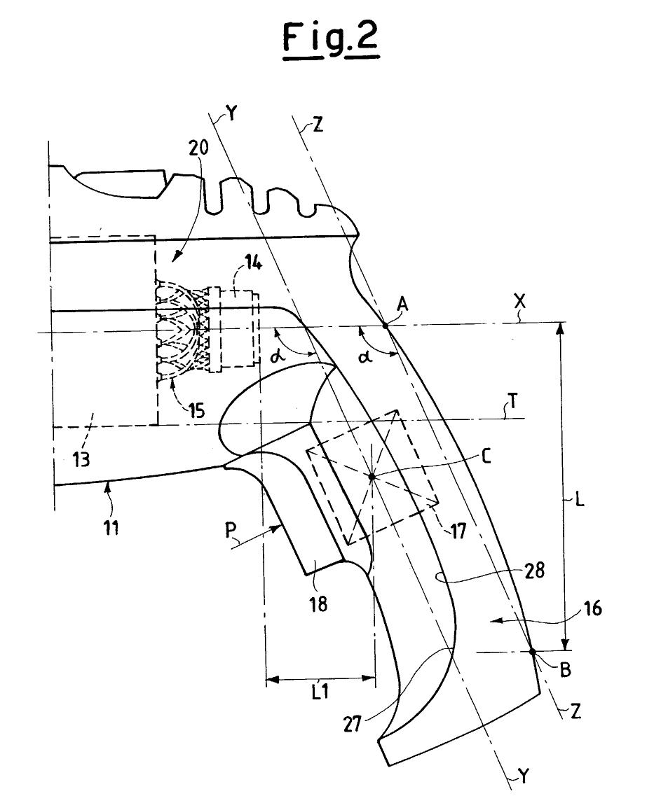

FIG. 2 shows a partial, enlarged side view of a hand held power tool, in particular a power tool, according to the present invention;

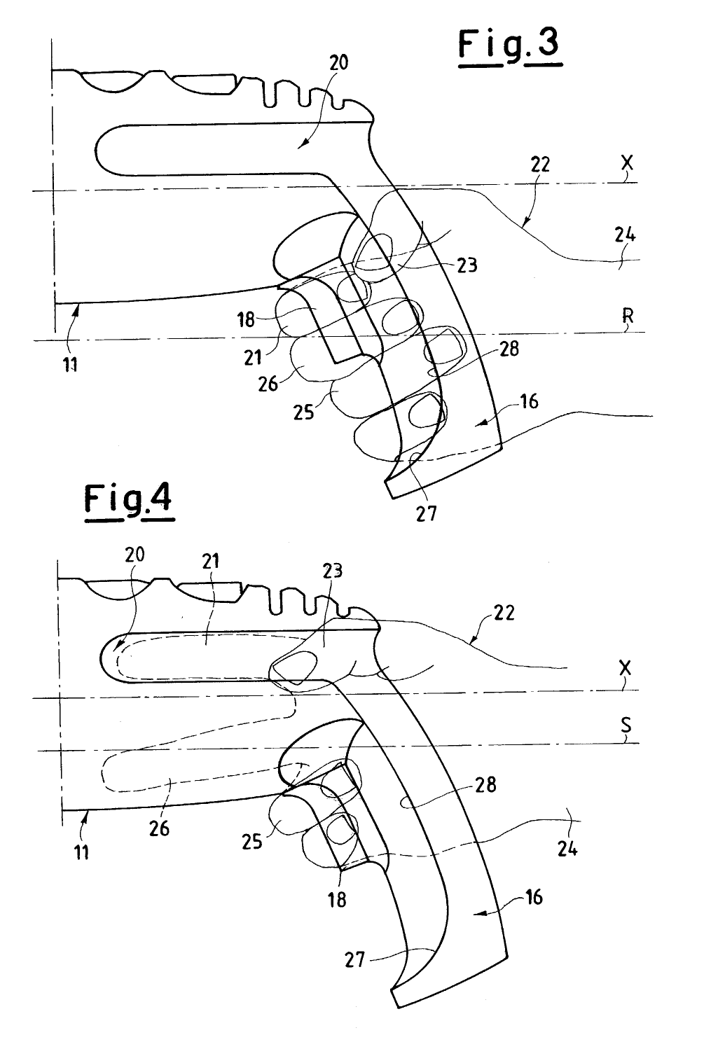

FIGS. 3 and 4 schematically illustrate two grip systems of the hand held power tool according to FIG. 2.

With particular reference to FIGS. 2-4 above, 11 indicates a main body of a hand held power tool, in particular a power tool, inside which the electric activation motor 13 of the tool, the motor commutator, generally indicated with 14, and the relative coiling 15, are mainly housed.

In the specific case in which the power tool consists of an electric drill or a screwdriver drill or pneumatic drill or hammer, on the external surface above the main body 11 of the drill, there is a longitudinal groove 20, which facilitates a firmer and safer hold of the power tool.

This kind of hold, particularly preferred by experts in the field as it enables a force to be applied in a direction which is parallel to the rotation axis of the motor allowing a reduction in the torque during use, consists of the possibility of inserting the index finger 21 of the hand 22 into the groove 20 and the mid-finger 26 in a parallel position, resting the thumb 23, in semi-opposition, in correspondence with the upper portion of the body 11 (see, in particular, FIG. 4 for a rapid verification), so as to exert greater force on the tool and have a better control of the machine, with respect to a conventional hold, of the “pistol” type (schematically illustrated in FIG. 3).

The hand held power tool also comprises a grip 16, which, according to the invention, has a particular configuration, suitable for maintaining optimum ergonomic conditions for the user, and which internally houses a main body of the start and/or drive switch, indicated with 17, activated by the pressure of a push-button 18, which protrudes from the profile of the grip 16 (towards the inside of the machine), making it accessible to the user's hand.

Some power tools also have a stop device, generally indicated with 19 in FIG. 1, which allows the push-button 18 to be kept in position without having to maintain the constant pressure of the fingers.

In particular, according to the present invention, a suitable angle of the grip 16 is created, with respect to the main body 11, to favour a correct positioning of the hand and forearm of the user during use.

More specifically, the hand held power tool, object of the present invention has a grip 16 having an median axis Y inclined, with respect to the longitudinal axis X of the body 11, at an obtuse angle α, substantially corresponding to the angle formed by the hand with the forearm in the so-called “neutral posture”, known to ergonomists as being the most advantageous in terms of comfort and prevention of a series of pathologies associated with the use of power tools.

This configuration, as already mentioned, provides an extremely convenient, comfortable, safe and efficient grip of the hand held power tool during work execution; in particular, the structural conformation of the grip 16 allows a force to be exerted, which is regularly distributed between the various muscles of the human body, and also allows minimum stress, with respect to that exerted on power tool grips of the traditional type.

FIG. 2 illustrates in detail the construction of the angle α; in this specific case, the inclination of the median axis Y of the grip 16, with respect to the longitudinal axis X of the body 11, is obtained by constructing a parallel to the line Z passing through points A (intersection point between the external profile of the grip 16 and longitudinal axis X) and B (point lying on the external profile of the grip 16, which is at a distance L, equal to at least 100 mm, from the longitudinal axis X).

It should be noted that the measurement of the distance L is justified by considerations of the normative type, which are used for the definition itself of grips for tools or power tools.

Finally, specific studies and experimental results have demonstrated that the ideal measurement of the angle α, obtained by the above-mentioned procedure and formed by the lines X and Y (or Z), is included within the range of values 108°-116°.

The particular inclination of the grip 16 forms an additional advantageous characteristic of the hand held power tool according to the invention.

This inclined configuration, in fact, allows the push-button 18 of the switch 17 to move in a direction (indicated by the arrow P of FIG. 2) which is substantially perpendicular to the median axis Y of the grip 16; this enables the user to maneuver the activation button 18 with much less force than is necessary with drive push-buttons of the traditional type, which are compelled to move in a substantially parallel direction to the axis X (see FIG. 1 for a rapid comparison).

In this respect, it should also be noted that the distance, indicated with L1 in FIG. 2, between the terminal surface of the commutator 14 of the electric motor 13 and the geometric centre C of the main body of the switch 17 is less than a pre-fixed size which, in illustrative and preferred but non-limiting embodiments of the present invention, is 70 mm.

The particular expedients outlined herein allow better results to be obtained in the control of the power tool, with the aim of improving work precision, and at he same time reducing fatigue and muscular stress which an arise mainly as a result of prolonged use.

FIGS. 3 and 4 specifically show the activation direction of the push-button of the switch and inclination of the grip 16; these figures also clearly illustrate how force and energy are applied by the human body to the power tool as efficiently as possible, as the application direction of said force is always parallel to the longitudinal axis X (corresponding to the rotation axis of the motor 13), both in the “pistol” type of grip (FIG. 3, in which the force application direction is indicated by the line R), and in the “upper” type of grip, with two fingers, preferred by experts (FIG. 4, in which the force application direction is indicated by the line S).

Furthermore, it can be seen that in both of the positions illustrated in FIGS. 3 and 4, the so-called “neutral posture” of the hand 22 and forearm 24 is maintained together with the necessary comfort in activating the push-button 18; on comparing FIGS. 1 and 2, it can be observed, in fact, how the distance between the push-button 18 and the holding groove 20 is extremely reduced in a power tool according to the present invention, with respect to a traditional power tool, with the consequent possibility of working in comfort and safety, with the ring finger (indicated with 25 in FIG. 4), on the above push-button 18, also selecting an “upper” hold position.

In this case, due to the impossibility of directly operating on the push-button 18 with an “upper” hold, the machine is gripped in the “upper” position when the motor is moving, after blocking the drive switch 19 with the “pistol” grip; in this kind of situation, however, if the tool stalls due to excessive friction and in the impossibility of releasing the switch, the power tool tends to rotate around the tool itself creating a dangerous situation for the operator.

The possibility of maintaining a firm and safe grip on the body 11 of the hand held power tool and of contemporaneously activating the push-button 18 with relative simplicity, is further guaranteed by the fact that, according to the present invention, the push-button 18 is situated in the upper part of the grip 16, so that the line T (see FIG. 2), which extends to the lower part of the motor 13, crosses the main body of the switch 17.

This can be achieved by housing the stop device 19, which is normally inserted inside the grip 16 and adjacent to the push-button 18 (as shown in FIG. 1), in a higher position and directly facing the commutator 14.

This particular arrangement of the switch 17 also avoids jeopardizing the encumbrance, which is comparable to that of power tools of the traditional type, at the same time maintaining an adequate inclination of the grip 16, in order to obtain the advantages of comfort and reduction in fatigue of the operator during use, as mentioned above.

The arrangement of the components present inside the hand held power tool is also designed in such a way as to avoid encumbrance of the power tool, above all in correspondence with the interface existing between the main body 11 and grip 16; compactness and reduction in encumbrance are, in fact, among the prerogatives most widely requested by the market.

Finally, the grip 16 has, in its lower part, an enlarged terminal section 27, which is specifically shaped for blocking the hand holding the power tool in position (in the case of a “pistol” hold), thus allowing an even firmer and safer grip.

As described in detail above, the inclined conformation of the grip 16, combined with its particular dimensions, surface geometry and transversal sections, allows a uniform distribution of the surface pressure on a wide area of the hand during the use of the hand held power tool.

The machine according to the invention is consequently comfortable for the user and allows an adequate force to be applied, maintaining constant control of the tool; in addition, the conformation of the grip, as already mentioned, prevents the onset of traumas of the muscular-skeletal type.

The diameter of the grip 16 is also optimized so as to ensure a uniform contribution of all fingers to the safety of the hold; the correct size of said diameter is obtained from experimental studies and biomechanical force measurements applied by the fingers and relative moments and is a compromise between an excessive bending angle of the five fingers in holding position (reduced diameter) and a non-adequate use of all fingers for their complete adhesion to the grip (due to an excessively large diameter).

On the basis of these considerations and further studies in the field, a grip 16 has been projected with an elliptical section, having a longitudinal line 28 on both opposite external surfaces; this line 28 is sufficiently prominent as to be instantly perceived upon touch, even in the present of work-gloves, to ensure a completely tridimensional perception on the part of the operator of the position of his hand on the grip 16, thus increasing accuracy of use of the hand held power tool, above all if used for precision works.

Finally, to facilitate a firm and safe hold on the rip 16, the surface of the grip must not be too smooth, allowing a symptomatic tactile contact and contributing to attenuating the vibrations transmitted by the machine to the hand and forearm.

The characteristics of the hand held power tool with an improved functionality, object of the present invention, are clearly illustrated by the above description, as also the advantages.

In particular, they mainly refer to the following aspects:

extension of the “active” area of the grip used for exerting the hold on the part of the user;

reduction in concentrated pressures on limited areas of the hand when holding the grip;

reduction in the necessity of exerting excessive force the part of human muscles and a consequent reduction in the causes of muscular-skeletal traumas for the machine operator;

uniformity of load distribution on the whole surface of the hand holding the power tool when operating;

extreme comfort and increase in the force exerted by the user during use;

adequate control of the hand held power tool especially for precision work;

more effective application of human force to the tool, whatever type of grip is adopted, with respect to traditional tools;

correct and optimum ergonomic design and maintaining, for all types of grips adopted, of the so-called “neutral posture” of the hand and forearm, providing advantages with respect to comfort and prevention of a series of pathologies connected with the use of power tools;

increase in work efficiency and productivity;

decrease in accident risks and improved capacity to reaction in emergency situations.

Finally, numerous variations can obviously be applied to the hand held power tool in question, without excluding any of the novelty principles which characterize the inventive idea illustrated, and it is also evident that, in the embodiment of the invention, the materials, forms and dimensions of the details illustrated can vary according to the demands and can be substituted with other technically equivalent alternatives.

1. A hand-held power tool with improved functionality, in particular an electric power tool, of the type comprising a body (11), inside which an electric motor (13) used for activating at least one tool, a commutation device (14) of the motor (13) and the relative coiling (15), are housed, and at least one grip (16), suitable for internally housing a trigger switch (17), activated by means of an external push-button (18) accessible to the user, characterised in that a longitudinal median axis (X) of said motor (13) forms an obtuse angle (α) with a line (Z) passing through a first intersection point (A) between the external profile of the grip (16) and said longitudinal axis (X) of the motor (13) and a second point (B) lying on said external profile of the grip (16), having a distance of at least 100 mm from said first intersection point (A) along the external profile of the grip (16) to reach said second point (B), said obtuse angle being defined starting from said longitudinal axis (X) of the motor (13) and turning in an anti-clockwise versus up to reach said line (Z) passing through said first (A) and said second point (B) along the external profile of the grip (16).

2. The hand-held power tool according to claim 1, characterised in that the magnitude of said obtuse angle (α) is between 108 and 116 degrees.

3. The hand-held power tool according to claim 1, characterised in that said external push-button (18) is situated in a higher portion of said grip (16), so that a line (T), which extends onto the lowest side of said electric motor (13), crosses the body of said trigger switch (17).

4. The hand-held power tool according to claim 1, characterised in that the distance (L1) between the terminal surface of said commutation device (14) of the electric motor (13) and the geometric centre (C) of said trigger switch (17) is less than a pre-fixed size, and, in particular, less than 70 mm.

5. The hand-held power tool according to claim 1, characterised in that, there is at least one longitudinal groove (20) housed on said external body (11) of the power tool, suitable for providing an upper grip of the tool, said grip involving the insertion of index finger (21) of the user's hand (22) inside said groove (20) and the mid-finger (26) in a parallel position, with the thumb (23) resting in semi-opposition.

6. The hand-held power tool according to claim 5 characterised in that said grip (16) is designed so as to allow a force to be applied in a direction parallel to the rotation axis of said electric motor (13) and to said longitudinal axis (X) of the power tool, respecting the ‘neutral posture’ of the operator's hand and forearm, when holding the power tool either in the upper or central section of the pistol grip.

7. The hand-held power tool according to claim 6, characterised in that, by holding both the upper or central section of the pistol grip, the “neutral posture” of the hand (22) and forearm (24) is maintained, providing necessary comfort in activating said external push-button (18), said push-button (18) being positioned at a close distance to said holding groove (20), allowing the ring finger (25) of the hand (22) to comfortably act on said push-button (18), also using an upper hold position.

8. The hand-held power tool according to claim 1, characterised in that said grip (16) has, in a lower portion, an enlarged terminal section (27), which is specifically shaped for blocking the hand (22) holding the power tool in position, thus allowing an even firmer and safer grip.

9. The hand-held power tool according to claim 1, characterised in that said grip (16) has an elliptical section and comprises at least one prominent longitudinal line (28), extremely perceptible to touch.
